(19) United States
(12) Patent Application Publication
(10) Pub. No.: US 2013/0241404 A1
(43) Pub. Date: Sep. 19, 2013

(54) ENCAPSULANT COMPOSITIONS AND METHODS FOR LIGHTING DEVICES

(71) Applicants: PETER GUSCHL, Carpinteria, CA (US); MATTHEW M. HALL, Alfred, NY (US); MONICA HANSEN, Santa Barbara, CA (US); Walter E. Mason, Alfred, NY (US)

(72) Inventors: PETER GUSCHL, Carpinteria, CA (US); MATTHEW M. HALL, Alfred, NY (US); MONICA HANSEN, Santa Barbara, CA (US); Walter E. Mason, Alfred, NY (US)

(21) Appl. No.: 13/419,590

(22) Filed: Mar. 14, 2012

(51) Int. Cl. H05B 33/04; H05B 33/10

(52) U.S. Cl. 313/512; 445/58

(57) ABSTRACT

The present disclosure relates generally to optical media and/or encapsulant precursors and optical media encapsulants produced therefrom, the optical media and/or encapsulants configurable for use in lighting devices. Specifically, the optical media and/or encapsulant precursors comprises at least one chemically functionalized silsesquioxane moiety. Methods of reducing degradation from heat and/or optical flux exposure using the optical media and/or encapsulant comprising chemically functionalized silsesquioxane are disclosed.

### TECHNICAL FIELD

The present disclosure relates generally to optical media and/or encapsulant precursors configurable for use in lighting devices. Specifically, the optical media and/or encapsulant precursors comprises at least one chemically functionalized silsesquioxane moiety. Methods of reducing degradation from heat and/or optical flux exposure using the optical media and/or encapsulant comprising one or more silsesquioxane moieties are also disclosed.

### BACKGROUND

Typical lighting devices comprise encapsulants and/or one or more lenses. Some types of lighting devices comprise solid state light emitters, such as LEDs. LED's typically contain an encapsulating dome or lens about the LED. Of the many materials used for the encapsulating dome (or lens) materials, silicones are widely used, primarily for a number of desirable properties. However, silicones are nonetheless hindered by their relatively low stability when exposed to significant heat as a result of conventional current densities in lighting devices, and/or in combination with intense optical fluxes that are needed for high flux, lighting-class LED-containing lighting devices. Under such conditions, silicone can degrade from the effects of heat and light, as well as suffer advanced aging effects, sometimes further augmented by incomplete curing during fabrication as an encapsulant. The result of this degradation is an undesirable shift of mechanical properties that can lead to discoloration of the encapsulant, continued physical degradation via cross-linking/chain scissioning of the encapsulant, and eventual cracking of the encapsulant, resulting in an unacceptable color shift of the lighting device and premature ending of its expected lifetime.

It is generally observed that the higher the optical flux density at a given temperature, the faster the failure of the encapsulant, or, the higher the given temperature at a optical flux density, the faster the failure of the encapsulant, for one or more of the above reasons. By way of example, for an LED lighting device, when the encapsulant stability is pushed passed its limit, a catastrophic failure occurs, typically observed around the top surface of a LED chip, as this is where the greatest heat and flux density interacts with the encapsulant. As a result, this interface becomes discolored or “charred” resulting in a severe decrease in luminous flux, as shown in FIGS. 1A and 1B, that show a before and after image, respectively, of a conventional encapsulant after high optical flux and heat exposure. The source of this charring may be at least partially linked to volatile organic compounds (VOCs), which may originate from the encapsulant and/or other organic chemical-containing LED components or, the encapsulant itself. With subsequent exposure to heat and high-energy photons emitted from the LED, the volatile compounds discolor and block the light emitted from the LED, among other effects.

### SUMMARY

In a first embodiment, a light emitting device is provided. The lighting device comprising: at least one light emitter; and an encapsulant in proximity to the at least one light emitter, the encapsulant comprising at least one functionalized polyhedral oligomeric silsesquioxane and/or at least one functionalized polysilsesquioxane.

In a second embodiment, a light emitting diode (LED) device is provided. The LED device comprising: a support having at least one LED thereon; and an optical media formed by the mixture or reaction product of (i) at least one functionalized polyhedral oligomeric silsesquioxane and/or at least one functionalized polysilsesquioxane, and comprising at least one functional group, the encapsulate capable of forming an optical media deposited on the LED and/or the support; and (ii) optionally, a catalyst.

In a third embodiment, a method of reducing degradation of an encapsulant of a lighting device is provided. The method comprising forming an encapsulant configurable for a lighting device, the encapsulant comprising at least one functionalized polyhedral oligomeric silsesquioxane and/or at least one functionalized polysilsesquioxane present in an amount sufficient to reduce degradation of the encapsulant during operation of the lighting device.

In a forth embodiment, a method of increasing the thermal conductivity of an encapsulant for a lighting device is provided. The method comprising providing an encapsulant precursor configured for forming an encapsulant for at least one light emitter, the encapsulant precursor comprising at least one functionalized polyhedral oligomeric silsesquioxane and/or at least one functionalized polysilsesquioxane present in an amount sufficient to increase the thermal conductivity of the encapsulant.

In a forth embodiment, a method of increasing the refractive index of an encapsulant for a lighting device is provided. The method comprising providing an encapsulant precursor configured for forming an encapsulant for at least one light emitter, the encapsulant precursor comprising at least one functionalized polyhedral oligomeric silsesquioxane and/or at least one functionalized polysilsesquioxane present in an amount sufficient to increase the refractive index of the encapsulant.

### BRIEF DESCRIPTION OF THE DRAWINGS

FIGS. 1A and 1B show a conventional encapsulant of an LED device before and after, respectively, exposure to high optical flux and heat from the LEDs.

FIG. 2 depicts representations of open cage and closed caged functionalized polyhedral oligomeric silsesquioxane moieties according to embodiments of the present disclosure.

FIG. 3 is a computer modeled heat distribution profile of an exemplary blue LED construct during operation with a 0.1 W/k thermal conductivity encapsulant (as a lens) and a phosphor binder.

FIG. 4 is a graphical representation of peak operating temperature as a function of thermal conductivity of the computer modeled LED construct of FIG. 3.

FIG. 5 is a graphical representation of a lighting device package light extraction as a function of the encapsulant/optical media index of refraction.

FIG. 6 is a schematic representation of an exemplary optical media/encapsulant fabrication process using embodiments of the present disclosure.

FIG. 7 is a graphical representation of experimental data of encapsulants according to embodiments of the present disclosure, showing the change in absorption as a function of time at elevated temperature.

FIG. 8 is a graphical representation of experimental data of optical media according to embodiments of the present disclosure, showing the change in absorption as a function of time at elevated temperature.

FIG. 9 is a graphical representation of experimental data of optical media according to embodiments of the present disclosure, showing the absorption of the optical media as a function of time at elevated temperature.

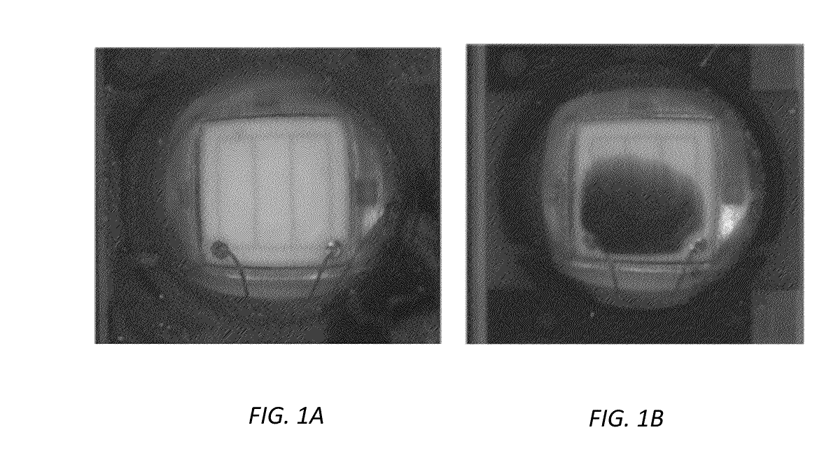

### DETAILED DESCRIPTION

The present disclosure provides for encapsulant precursors comprising at least one chemically functionalized silsesquioxane moiety. The chemically functionalized silsesquioxane moieties can be dispersed or otherwise distributed in an encapsulant precursor (hereinafter also referred to as a “matrix”) suitable for lens for use in lighting devices. It has been observed that POSS moieties effectively modify selective characteristics of an encapsulant with respect to its thermal and optical properties. Thus, alone or in combination with an encapsulant precursor, POSS moieties provide improved resistance to thermal degradation, optical degradation, and thermal-optical degradation, including resistance to yellowing. In addition, alone or in combination with an encapsulant precursor, chemically functionalized silsesquioxane moieties can improve the refractive index, (“refractive index”) and/or thermal conductivity of encapsulant.

Accordingly, in one embodiment of the present disclosure is provided an encapsulant precursor and/or an encapsulant comprising at least one POSS moiety. In some aspects, one or more of the encapsulant precursors and/or one or more POSS moieties have at least one reactive group suitable for physical or chemical coupling.

The encapsulant precursor comprising at least one POSS moiety improves the useful life of lighting devices. In one aspect, the encapsulant precursor comprising at least one POSS moiety improves the useful life of light-emitting diode (LED) containing devices. The encapsulant precursor comprising at least one POSS moiety provides one or more of improved high-temperature stability of the lens material, enhances stability to high optical flux density exposure for the optical/encapsulant material, increases thermal conductivity of the lens material, and increased refractive index of the optical/encapsulant material.

The following description and examples illustrate some exemplary embodiments of the disclosed disclosure in detail. Those of skill in the art will recognize that there may be numerous variations and modifications of this disclosure that may be encompassed by its scope. Accordingly, the description of a certain exemplary embodiment is not intended to limit the scope of the present disclosure.

The terminology used herein is for the purpose of describing particular embodiments only and is not intended to be limiting of the inventive subject matter. As used herein, the singular forms “a”, “an” and “the” are intended to include the plural forms as well, unless the context clearly indicates otherwise. With reference to encapsulant precursor, the term “material” is inclusive of one or more “materials.” It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element such as a layer, region or substrate is referred to herein as being “deposited on” or “on” or extending “onto” another element, it can be directly on or extend directly onto the other element or intervening elements may also be present. In contrast, when an element is referred to herein as being deposited “directly on” or extending “directly onto” another element, there are no intervening elements present. Also, when an element is referred to herein as being “connected” or “coupled” to another element, it can be directly connected or coupled to the other element or intervening elements may be present. In contrast, when an element is referred to herein as being “directly connected” or “directly coupled” to another element, there are no intervening elements present. In addition, a statement that a first element is “on” a second element is synonymous with a statement that the second element is “on” the first element.

Although the terms “first”, “second”, etc. may be used herein to describe various elements, components, regions, layers, sections and/or parameters, these elements, components, regions, layers, sections and/or parameters should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure. Relative terms, such as “lower”, “bottom”, “below”, “upper”, “top” or “above,” may be used herein to describe one element's relationship to another element as illustrated in the Figures. Such relative terms are intended to encompass different orientations of the device in addition to the orientation depicted in the Figures. For example, if the device in the Figures is turned over, elements described as being on the “lower” side of other elements would then be oriented on “upper” sides of the other elements. The exemplary term “lower”, can therefore, encompass both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The phrase “lighting device”, as used herein, is not limited, except that it indicates that the device is capable of emitting light. That is, a lighting device can be a device which illuminates an area or volume, e.g., a structure, a swimming pool or spa, a room, a warehouse, an indicator, a road, a parking lot, a vehicle, signage, e.g., road signs, a billboard, a ship, a toy, a mirror, a vessel, an electronic device, a boat, an aircraft, a stadium, a computer, a remote audio device, a remote video device, a cell phone, a tree, a window, an LCD display, a cave, a tunnel, a yard, a lamppost, or a device or array of devices that illuminate an enclosure, or a device that is used for edge or back-lighting (e.g., back light poster, signage, LCD displays), bulb replacements (e.g., for replacing AC incandescent lights, low voltage lights, fluorescent lights, etc.), lights used for outdoor lighting, lights used for security lighting, lights used for exterior residential lighting (wall mounts, post/column mounts), ceiling fixtures/wall sconces, under cabinet lighting, lamps (floor and/or table and/or desk), landscape lighting, track lighting, task lighting, specialty lighting, ceiling fan lighting, archival/art display lighting, high vibration/impact lighting—work lights, etc., mirrors/vanity lighting, or any other light emitting device.

The terms “crosslink” and “crosslinking” as used herein refer without limitation to joining (e.g., adjacent chains of a polymer) by creating covalent or ionic bonds. Crosslinking can be accomplished by known techniques, for example, thermal reaction, chemical reaction or ionizing radiation (for example, UV/Vis radiation, electron beam radiation, X-ray, or gamma radiation, catalysis, etc.).

The phrase “encapsulant precursor” is used herein interchangeably with “encapsulant matrix” and “matrix,” and refers without limitation to one or more materials or one or more compositions of matter that are capable of transitioning from a liquid to a solid or gel suitable for use in or with a light emitting device as an encapsulant of, around, or about one or more components of the lighting device. In one aspect, the “encapsulant precursor” comprises one or more silsesquioxane moieties as described below. In another aspect, the silsesquioxane or a chemically modified form thereof is essentially the “encapsulant precursor.” The term “encapsulant” as used herein, unless indicated to the contrary, is understood to be substitutable with “an optical media” and/or an “optical lens”, for example, an optical media or lens formed about a light emitter, in the embodiments disclosed herein

The terms “phosphor” and “phosphors” is used herein to refer to any material or composition of matter that absorbs light at one wavelength and re-emits light at a different wavelength, regardless of the delay between absorption and re-emission, and regardless of the wavelengths involved. Accordingly, “phosphors” encompasses “lumiphors,” “wavelength converting materials,” “luminescent materials,” and “color shifting elements,” and is used herein to encompass such materials that are fluorescent and/or phosphorescent and/or can be particles which absorb light having an absorbing wavelength(s) and re-emit light having longer or shorter wavelength(s). Inclusion of phosphor materials in LED devices can be accomplished in a variety of ways, one representative way being by adding the phosphor materials to a clear or transparent encapsulant precursor as further discussed herein, for example, by a blending or mixing process.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Encapsulant Precursors

The encapsulant precursor is any one or more precursors that are suitable for and capable of providing an optically transparent encapsulant for use in a lighting device. In one aspect, the encapsulant precursor is suitable for use with solid state light emitters, including light emitting diode (LED) light sources, either a single LED or arrays of LEDs of the same or different light emitting characteristic. The encapsulant precursors can include one or more precursors. In one aspect, the encapsulant precursor comprises one precursor. In another aspect, the encapsulant precursor is comprised of a “two-part composition”. The encapsulant precursor provides for a cured or set encapsulant, which can be an optical lens that contains one or more POSS moieties and optionally other components. The cured or set encapsulant prepared from the encapsulant precursors includes, sol-gels, gels, glasses, ceramics, cross-linked polymers, and combinations thereof. Examples of cured or set matrixes include, for example, one or more polymers and/or oligomers of silicones, e.g., polysiloxanes (e.g., polydialklysiloxanes (e.g., polydimethylsiloxane “PDMS”, polyalkylaryl siloxanes and/or polydiarylsiloxanes), epoxy resins, polyesters, polyarylesters, polyurethanes, cyclic olefinic copolymers (COC's), polynorbornenes, or hybrids and/or copolymers thereof, or such materials in combination with other components. Examples of LED encapsulants include, without limitation, LIGHT CAP® LED Casting Resin 9622 acrylated polyurethane, (Dynamax Corp., Torringtion Conn.); LPS1503, LPS2511, LPS3541, LPS5355, KER-6110, KER-6000, KER-6200, SCR-1016, ASP-1120, ASP-1042, KER-7030, KER-7080 (Shin-Etsu Chemical Co., Ltd, Japan); QSil216, QSil218, QSil222, and QLE1102 Optically Clear, 2-part Silicone encapsulant (ACC Silicones, The Amber Chemical Company, Ltd.), United Kingdom); LS3-3354 and LS-3351 silicone encapsulants from NuSil Technology, LLC (Carpinteria, Calif.); Epic 57253 Polyurethane encapsulant (Epic Resins, Palmyra, Wis.); OE-6630, OE-6636, OE-6336, OE-6450, OE-6652, OE-6540, TSX-7630, TSX-7640, TSX-7620, TSX-7660, OE-6370M, JCR-6110, JCR-6175, EG-6301 (Dow Corning, Midland, Mich.).

A number of polysiloxanes, with varying backbone structure are suitable for use as an encapsulant precursor. With reference to Equation (1), various forms of polysiloxanes, e.g. the M, T, Q, and D backbones, where R is, independently, alkyl or aryl, are presented:

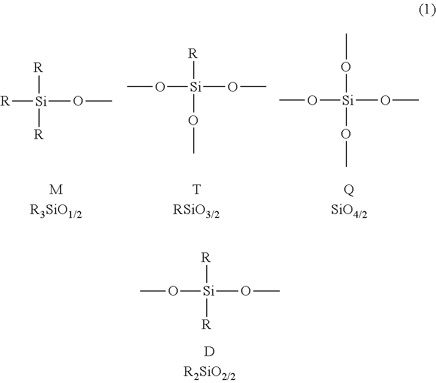

In one example poly(dimethylsiloxane) (PDMS) with hydroxyl (—OH) end-capped groups represents a difunctional, D-type encapsulant precursor, that has undergone condensation reactions, forming a linear chain of dimethylsiloxane groups. End-capped hydroxyl groups with either POSS moieties provides for further condensation with any hydrolyzed precursors in which to yield longer linear chains and/or branched structures (incorporating T and Q precursor types) and other chemical functionalities (e.g. methyl, Si—H, vinyl, hydroxyl, etc.). If either the Si—H or Si-vinyl chemical groups are present in or at the terminus of PDMS chains, the polymer or oligomer can be attached to other molecules through hydrosilylation with the respective (Si-vinyl, Si—H) chemical groups, using a platinum catalyst, for example.

Other encapsulant precursor structures can be fabricated by including T- and/or Q-type precursors with functional groups with a PDMS structure as described above. These precursor types allow for branching of the linear PDMS chain and possess a more inorganic content relative to the M- and D-types. T- and Q-type precursor may be used provided excess levels are not used such that the structures with high inorganic content and a highly rigid character result, which may have an adverse effect on mechanical properties (e.g. brittleness, porosity, etc.) and processing (e.g. lower moldability) of the final encapsulant. Thus, in one aspect, a PDMS oligomer precursor with one or more chemical groups are used. For example, a PDMS oligomer having one or more phenyl side groups and Si—H and/or vinyl end-terminated groups is used.

In one aspect, one or more polymers and/or oligomers of polysiloxanes are used. The one or more polymers and/or oligomers of polydialklysiloxanes (e.g., polydimethylsiloxane PDMS), polyalkylaryl siloxanes and/or polydiarylsiloxanes can comprise one or more functional groups selected from acrylate, methacrylate, acrylamide, methacrylamide, fumarate, maleate, norbornenyl and styrene functional groups, and/or polysiloxanes with multiple reactive groups such as hydrogen, hydroxy, alkoxy, amine, chlorine, epoxide, isocyanate, isothiocyanate, nitrile, vinyl and thiol functional groups. Some specific examples of such polysiloxanes include vinyl-terminated-, hydroxyl-terminated, or methacrylate-terminated polydimethyl-co-diphenyl siloxanes and/or polydimethyl-co-methylhydro-siloxanes. In one aspect, the function group is located at one or both terminuses of the encapsulant precursor.

### Silsesquioxanes

Silsesquioxane moieties are silicon-containing cage-like molecules based upon the structure of oxygen and silicon tetrahedrons. As used herein, the term “silsesquioxane” is a compound generally represented with the empirical chemical formula RSiO_{1.5} where Si is the element silicon, O is oxygen and R is, independently, hydrogen, an alkyl, alkene, aryl, arylene group, or hydroxyl.

The term “polyhedral oligomeric silsesquioxane” or “POSS” as used herein describes a type of three-dimensional siloxane molecule in which at least two siloxane rings form essentially a rigid molecular structure or “cage”. Both open-cage and closed cage POSS moieties are encompassed in the present disclosure. The term “closed-cage POSS” refers generally to a polyhedral oligomeric silsesquioxane moiety in which each ring-member silicon atom is linked to three other ring-member silicon atoms through oxygen atoms. The term “open-cage POSS” refers generally to a polyhedral oligomeric silsesquioxane moiety in which at least two silicon atoms are each linked to no more than two other ring-member silicon atoms through oxygen atoms.

Exemplary POSS materials comprise nanometer-sized silica cages (nanometer-, nano-sized, and nano-cage referring generally to the spacing between silicon atoms that comprise an “edge” of a cube or partial cube structure formed of a silicon-oxygen-silicon bond) that can be completely or partially condensed. Completely condensed (“closed”) POSS “cages” typically represented by the empirical formula “Si₈O₁₂” can comprise up to eight chemical groups (octafunctional), each of the up to eight groups independently can be reactive or non-reactive, chemical functional groups. Partially condensed (“open”) POSS cages, typically represented by empirical formulas “Si₇O₉” or “Si₃O₁₀” can possess up to ten, up to eleven, and up to twelve chemical functional groups.

As used herein, the terms “polyhedral oligomeric silsesquioxane” and “polysilsesquioxane” (hereinafter also referred to collectively as “POSS-moieties”) are materials represented by or including the formula [RSiO_{1.5}]ₙ where n is the degree of polymerization within the material, and R is independently, hydrogen or an organic substituent (“R group”), such as a cyclic or linear aliphatic or aromatic group, the substituent R group optionally containing chemical functional groups, such as, silyl, alcohols, esters, amines, carboxyls, epoxy, olefins, (methyl)acrylates, ethers, imides, halides, haloaryl, and/or haloalkyl. Functionalized polyhedral oligomeric silsesquioxanes and/or polysilsesquioxanes comprise at least one substituent R group containing chemical functional groups. In one aspect the chemical functional groups are reactive, e.g., capable of forming chemical bonds and/or crosslinks.

Polyhedral oligomeric silsesquioxanes and/or polysilsesquioxanes may be either homoleptic systems containing only one type of R group, or heteroleptic systems containing more than one type of R group. POSS-moieties are inclusive of homo- and co-polymers derived from moieties comprising silsesquioxanes with functionality, including mon-functionality and multi-functionality. Poly-POSS moieties encompass partially or fully polymerized POSS moieties as well as grafted and/or appended POSS moieties, end-terminated POSS moieties, and combinations.

In one aspect, POSS moieties of the present disclosure are represented generally by Formula (1) below:

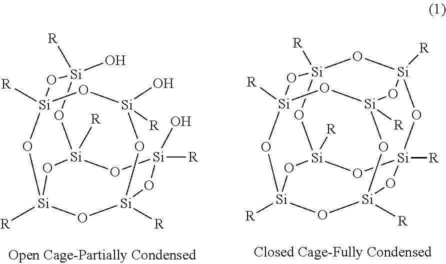

showing a representative example of an open cage, partially condensed and closed cage, fully condensed POSS moiety, wherein the R groups may be the same or different, optionally with at least one of the R groups being a group having chemical functionality, further described below. In one aspect, at least one of the R groups is associated with and/or provides an encapsulant precursor. In other aspects, at least one of the R groups is a reactive group suitable for physical or chemical association or reaction, to provide, or be in combined with, one or more encapsulant precursors. The R group may be the same or different, selected from hydrogen, hydroxy, alkoxy, amine, chlorine, epoxide, isocyanate, methacrylate, acrylate, methacrylamide, acrylamide, nitrile, isocyanate, isothiocyanate, norbornenyl, vinyl, styrenyl, or thiol. In the above aspects, at least one of the R groups can optionally be a non-reactive group, which may be the same or different, independently selected from substituted, branched, un-branched, cyclic, or acyclic C₁₋₃₀ alkyl, and aryl and/or substituted, branched, or un-branched C₆₋₃₀ substituted aryl groups.

Unless specifically described, hereinafter the terms “POSS” and “POSS moiety” are used interchangeably and are inclusive of polyhedral oligomeric silsesquioxanes, and compounds, organic polymers/oligomers, inorganic polymers/oligomers, and/or organic-inorganic polymers containing one or more open and/or closed cage silsesquioxane moieties, with any of the R groups and/or chemical functional groups, described above.

Examples of suitable POSS moieties encompassed by the present disclosure include, but are not limited to, the following open-cage and/or closed cage molecules, having from zero up to and including eight non-reactive or reactive sites, where each of the sites, independently, can be substituted/un-substituted alkyl-, branched/un-branched alkyl-, cyclic/acyclic alkyl-, hydroxyl-, alkoxyl-, amine-, halo/chloro-, epoxy-, isocyanate-, acrylate/methacrylate-, acrylamide/methacrylamide-, nitrile-, norbornenyl-, vinyl-, hydrogen-, thiol-, silanol-, aryl, substituted aryl, and/or styrenyl-containing groups.

Examples of hydroxy-containing POSS moieties include for example, but are not limited to, octahydroxypropyldimethylsilyl-POSS.

Examples of alkoxy-containing POSS moieties include for example but are not limited to diethoxymethylsilylethyl-cyclohexyl-POSS; diethoxymethylsilylethyl-isobutyl-POSS; diethoxymethylsilylpropyl-cyclohexyl-POSS; diethoxymethylsilylpropyl-isobutyl-POSS; ethoxydimethylsilylethyl-cyclohexyl-POSS; ethoxydimethylsilylethyl-isobutyl-POSS; ethoxydimethylsilylpropyl-cyclohexyl-POSS; ethoxydimethylsilylpropyl-isobutyl-POSS; diethoxymethylsilylethyl-cyclohexyl-POSS; triethoxysilylethyl-isobutyl-POSS; triethoxysilylpropyl-cyclohexyl-POSS and triethoxylsilylpropyl-isobutyl-POSS.

Examples of amine-containing POSS moieties include for example but are not limited to aminopropyl cyclohexyl-POSS, aminopropyl isobutyl-POSS, aminopropyl isooctyl-POSS and octaminophenyl POSS. In one aspect, with aminopropyl isobutyl-POSS as the preferred.

Examples of chlorosilane-containing POSS moieties include for example but are not limited to monochlorocyclohexyl-POSS; monochlorocyclopentyl-POSS; monochloroisobutyl-POSS; chlorodimethylsilylethyl isobutyl-POSS; chlorodimethylsilylpropyl isobutyl-POSS; chlorodimethylsilylpropyl cyclohexyl-POSS; dichloromethylsilylethyl isobutyl-POSS; dichloromethylsilylpropyl isobutyl-POSS; dichloromethylsilylpropyl cyclohexyl-POSS; trichlorosilylethyl isobutyl-POSS; trichlorosilyipropyl isobutyl-POSS; trichlorosilylpropyl cyclohexyl-POSS and octa(chlorodimethysilylethyl)-POSS.

Examples of epoxide-containing POSS moieties include for example but are not limited to epoxypropyl isobutyl-POSS; epoxypropyl cyclopentyl-POSS; glycidyl cyclohexyl-POSS; glycidyl isobutyl-POSS; glycidyl isooctyl-POSS; glycidyl phenyl-POSS; octaepoxycyclohexyldimethylsilyl-POSS; octaglycidyldimethylsilyl-POSS; triglycidyl cyclohexyl-POSS; triglycidyl cyclopentyl-POSS; triglycidyl isobutyl-POSS and triglycidyl ethyl-POSS.

Examples of isocyanate-containing POSS moieties include for example but are not limited to isocyanatopropyldimethylsiloxy cyclohexyl-POSS and isocyanatopropyldimethylsiloxy isobutyl-POSS.

Examples of acrylate/methacrylate-containing POSS moieties include for example but are not limited to acryloxypropyl cyclohexyl-POSS; acryloxypropyl cyclopentyl-POSS; acryloxypropyl isobutyl-POSS; methacryloxypropyl cyclohexyl-POSS; methacryloxypropyl cyclopentyl-POSS; methacryloxypropyl isobutyl-POSS; methacryloxypropyl ethyl-POSS; methacryloxypropyl isooctyl-POSS; methacryloxypropyl phenyl-POSS; octamethacryloxypropyl-POSS; methacryloxypropyldimethylsilyl cyclopentyl-POSS and methacryloxypropyl-dimethylsilyl cyclopentyl-POSS.

Examples of acrylamide/methacrylamide-containing POSS moieties include for example but are not limited to acrylamidopropyl cyclohexyl-POSS; acrylamidopropyl cyclopentyl-POSS; acrylamidopropyl cyclohexyl-POSS; methacrylamidopropyl cyclohexyl-POSS; methacrylamidopropyl cyclopentyl-POSS; methacrylamidopropyl cyclohexyl-POSS.

Examples of nitrile-containing POSS moieties include for example but are not limited to cyanopropyl cyclohexyl-POSS; cyanopropyl cyclopentyl-POSS; cyanopropyl isobutyl-POSS; cyanoethyl cyclohexyl-POSS; cyanoethyl cyclopentyl-POSS and cyanoethyl isobutyl-POSS.

Examples of norbornenyl-containing POSS moieties include for example but are not limited to norbornenylethyl cyclohexyl-POSS; norbornenylethyl cyclopentyl-POSS; norbornenylethyl isobutyl-POSS; trisnorbornenylethyldimethylsilyl cyclopentyl-POSS; trisnorbornenylethyldimethylsilyl cyclohexyl-POSS; and trisnorbornenylethyldimethylsilyl isobutyl-POSS.

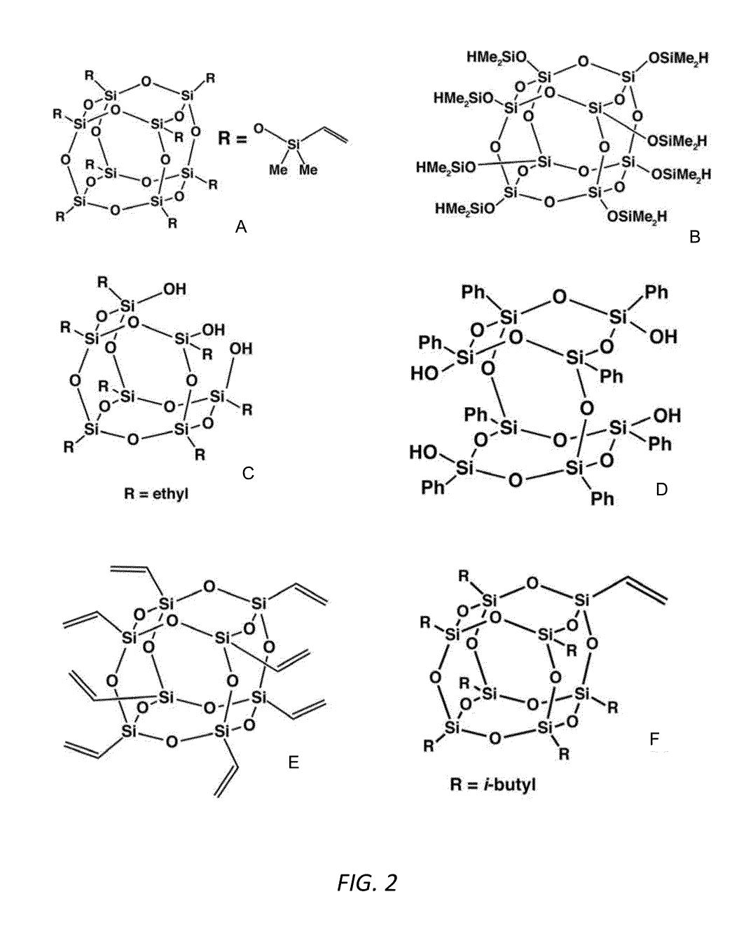

Examples of vinyl-containing POSS moieties include for example but are not limited to allyl cyclohexyl-POSS; allyl cyclopentyl-POSS; allyl butyl-POSS; allyidimethylsilylcyclopentyl-POSS; cyclohexenylethyl cyclopentyl-POSS; vinyldimethylsilyl cyclopentyl-POSS; vinyldiphenylsilyl cyclopentyl-POSS; vinyl cyclopentyl-POSS; vinyl cyclohexyl-POSS; vinyl isobutyl-POSS (as depicted in FIG. 2-F); tris-vinyldimethyl cyclohexyl-POSS; tris-vinyidimethyl cyclopentyl-POSS; tris-vinyidimethyl isobutyl-POSS; octavinyl-POSS, and octavinyldimethyl-POSS. In one aspect; octavinyl-POSS (as depicted in FIG. 2-E) and octavinyldimethylsilyl-POSS (as depicted in FIG. 2-A), is preferably used.

Examples of hydrogen-containing POSS moieties include for example but are not limited to dimethylhydrosilyl cyclohexyl-POSS; dimethylhydrosilyl cyclopentyl-POSS; dimethylhydrosilyl isobutyl-POSS; monohydro cyclohexyl-POSS; monohydro isobutyl-POSS; octadimethylhydrosilyl-POSS (as depicted in FIG. 2-B); trisdimethylhydrosilyl cyclohexyl-POSS; and trisdimethylhydrosilyl isobutyl-POSS.

Examples of thiol-containing POSS moieties include for example but are not limited to mercaptopropyl cyclohexyl-POSS; mercaptopropyl cyclopentyl-POSS; and mercaptopropyl isobutyl-POSS.

Examples of silanol-containing POSS moieties include for example but are not limited to monohydroxy cyclohexyl-POSS; monohydroxy cyclopentyl-POSS; monohydroxy isobutyl-POSS; trishydroxy cyclohexyl-POSS; trishydroxy cyclopentyl-POSS; trishydroxy ethyl-POSS; (as shown in FIG. 2-C), trishydroxy isobutyl-POSS; trishydroxy isooctyl-POSS; and trishydroxy phenyl-POSS, (as shown in FIG. 2-D).

Examples of styrene-containing POSS moieties include for example but are not limited to p-styryl cyclohexyl-POSS; p-styryl cyclopentyl-POSS and p-styryl isobutyl-POSS.

Some reactive POSS moieties having multiple reactive sites have different reactive groups that are not reactive toward each other. Such POSS moieties are nonetheless useful as a component in an encapsulant precursor or encapsulant in accordance with the present disclosure. Some examples of such POSS moieties include, for example, norbornenylethyldimethyl-silyldihydroxy isobutyl-POSS (having olefin and hydroxy functionality) and methacryloxypropylsilyldihydroxy isobutyl-POSS (having methacrylate and hydroxy functionality). Other combinations of compatible chemical functionality associated with the POSS moiety can be employed.

In another embodiment, the encapsulant precursors comprise at least one homo- and co-polymers (or oligomers) formed with POSS moieties as part of the polymer backbone and/or as an appendage from the polymer, inclusive of polysilsesquioxanes described above. Examples of polysilsesquioxanes include, for example, polystyryl-POSS, poly{meth}acrylate-POSS, polynorbornyl-POSS, polyvinyl-POSS, polyepoxy-POSS, and polysiloxane-POSS. Poly-POSS moieties are further inclusive of the aforementioned polymers and other functionalized polymers that are configured to incorporate the silsesquioxane functionality as an appendage from, or within a polymer backbone. Examples of polysilsesquioxanes suitable for encapsulant precursors or, by way of example, for forming optical media and/or lenses for an LED assembly include, for example:

poly(propylmethacryl POSS-co-methylmethacrylate) and/or poly(propylmethacryl POSS-co-styrene);

poly (1-methoxy-4-(3-propyloxy-heptaisobutyl-POSS)-2,5-phenylenevinylene)-co-(1-methoxy-4-(2-ethylhexyloxy)-2,5-phenylenevinylene) (60:40 mole:mole);

poly[(propylmethacryl-heptaisobutyl-POSS)-co-(t-butyl methacrylate)] POSS;

poly[(propylmethacryl-heptaisobutyl-POSS)-co-(methyl methacrylate)] POSS;

poly[(propylmethacryl-heptaisobutyl-POSS)-co-(n-butyl methacrylate)] POSS;

poly[(propylmethacryl-heptaisobutyl-POSS)-co-hydroxyethyl methacrylate] POSS;

poly[(propylmethacryl-heptaisobutyl-POSS)-co-styrene] POSS;

poly[1-methoxy-4-(3-propyloxy-heptaisobutyl-POSS)-2,5-phenylenevinylene];

poly[1-methoxy-4-(3-propyloxy-heptaisobutyl-POSS)-2,5-phenylenevinylene]-co-[1-methoxy-4-(2-ethylhexyloxy)-2,5-phenylenevinylene] (30:70 mole:mole); and mixtures thereof. In one aspect of the present disclosure, the at least one polysilsesquioxane as described immediately above are employed solely as the encapsulant precursor, or as the major component of the encapsulant precursor.

Chemically Reactive POSS Combinations as/or with Encapsulant Precursor

In another aspect of the present disclosure, one or more POSS moieties are physically and/or chemically mixed or combined with encapsulant precursors for producing an encapsulant. The method of physical and/or chemical incorporation can be different depending on the non-reactive and/or reactive groups of the POSS and the encapsulant precursors used. For example, the POSS moieties can have functional groups reactive with one or more reactive groups of the POSS and/or encapsulant precursors. In one example, POSS moieties having Si—OR groups, where R is H, methyl, ethyl, propyl, butyl, isobutyl, and other lower alkyls (branched, linear, acyclic or cyclic) can be, used with corresponding encapsulant precursors having the Si—OR groups, where R is H, methyl, ethyl, propyl, butyl, isobutyl, and other lower alkyls (branched, linear, acyclic or cyclic). In another example, mixtures of POSS moieties with, independently, one or more of Si—H and/or Si-vinyl groups, and/or Si—OH groups, can be used. In one aspect, where the POSS moiety is essentially the encapsulant precursor, mixtures of POSS moieties with, independently, one or more of Si—H and/or Si-vinyl groups, and/or Si—OH groups, can be used.

By way of example, POSS moieties having vinyl, acrylic, and/or styrene groups attached to Si, the polysilsesquioxanes can be mixed with the encapsulant precursor to provide an encapsulant through a typical free radical copolymerization type reaction. For POSS moieties having alcohol, alkoxyl, amine, thiol, epoxy and isocyanate groups attached to Si, the POSS moieties can be mixed into the encapsulant precursor and provide lenses through the typical epoxy or urethane, resin reactions. POSS moieties having acid or acid chloride groups can be physically or chemically incorporated into the encapsulant precursor in a similar manner. For example, the POSS moieties can interact with the encapsulant precursor through imide coupling or via ester/amide reactions between carboxyl, —OH, —SH or —NH functional groups of either the POSS moiety or the encapsulant precursor.

One or more POSS moieties having one or more Si—H (silyl) groups can be added to encapsulant precursors, e.g. silicones having Si-vinyl functional groups) to provide an encapsulant via a platinum metal catalyzed hydrosilation reaction between the POSS hydride functionality and encapsulant precursor Si-vinyl functional groups. The silyl and Si-vinyl functional groups can be reversed, that is, Si-vinyl groups can be associated with the POSS moiety and silyl functional groups can be associated with the encapsulant precursors. Likewise, combinations of POSS moieties comprising, independently, Si—H and Si-vinyl functional groups can be used as the encapsulant precursors.

Encapsulant Precursor Compositions with POSS Moieties

In various aspects, encapsulant precursors comprise one or more reactive silicone containing polymers (and/or oligomers or formulations comprising same) in combination with a POSS moiety. Such one or more POSS moieties having one or more reactive functional groups can be mixed with reactive silicone containing polymers. Examples of reactive silicone containing polymers with reactive groups capable of interacting with the reactive functional groups of POSS moieties, include for example, linear or branched polysiloxanes containing at least one acrylate, methacrylate, acrylamide, methacrylamide, fumarate, maleate, norbornenyl and styrene functional groups, and/or linear or branched polysiloxanes with multiple reactive groups such as Si—H (silyl), hydroxy, alkoxy, amine, chlorine, epoxide, isocyanate, isothiocyanate, nitrile, vinyl, and thiol functional groups. Some specific examples of such linear or branched polysiloxanes include hydride-terminated, vinyl-terminated or methacrylate-terminated polydimethyl-co-diphenyl siloxanes and polydimethyl-co-methylhydro-siloxanes. The reactive groups can be located at one or both terminuses of the reactive silicone polymers, and/or anywhere along the backbone and/or branches of the polymer.

In one aspect, an exemplary example of a silicone encapsulant precursor comprises linear siloxane oligomers, with a combination of methyl and phenyl chemical groups, coupled with a POSS moiety with up to eight “R” chemical groups; where R is independently, hydrogen, vinyl or hydroxyl, so as to be associated with the encapsulant precursor for providing one or more of reduction of thermal degradation, reduction of optical degradation, reduction of thermal and optical degradation, and/or increase of index of refraction and/or increase of thermal conductivity of encapsulant. “Associated” and “coupled” as used in this context includes, without limitation, covalent, ionic and/or Van der Walls interaction between one or more of the R groups of POSS moiety with the POSS moiety, and/or with the encapsulant precursor.

In another aspect, an exemplary example of a silicone encapsulant precursor comprises branched siloxane oligomers, with a combination of methyl and phenyl chemical groups, coupled to a POSS moiety with up to eight “R” chemical groups, where R is independently hydrogen, vinyl or hydroxyl) associated with the encapsulant precursor.

In another aspect, an exemplary example of a silicone encapsulant precursor comprises linear siloxane oligomers, with a combination of methyl, phenyl and hydroxyl or alkoxy chemical groups, coupled to a POSS moiety with one to four “R” chemical groups (where R is hydrogen, vinyl or hydroxyl) associated with the encapsulant.

In another aspect, an exemplary example of a silicone encapsulant precursor comprises branched siloxane oligomers, with a combination of methyl, phenyl and hydroxyl or alkoxy chemical groups, coupled to a POSS moiety with one to four “R” chemical groups (where R is hydrogen, vinyl or hydroxyl) associated with the encapsulant.

Any POSS moiety combination mentioned above can act as the encapsulant precursor to provide an optical media and/or an optical lens for a lighting device, for example, an LED lighting device for providing of one or more of reduction of thermal degradation, reduction of optical degradation, reduction of thermal and optical degradation, and/or increase of index of refraction and/or increase of thermal conductivity of encapsulant.

In yet another aspect, the POSS moiety or POSS-containing moiety is blended, admixed, distributed, dispersed, or otherwise combined with the encapsulant precursor, as mentioned above, substantially without any chemical reaction taking place between the POSS moiety and the encapsulant precursor prior to and including forming encapsulant. Thus, in this specific aspect only, the POSS moiety is essentially an additive to the encapsulant precursor and the resultant optical medium or lens, the POSS moiety providing for reduction of one or more of thermal degradation, optical degradation, thermal and optical degradation, and/or increase of index of refraction and/or thermal conductivity of encapsulant.

A plurality of POSS moieties can be combined to form the LED encapsulant precursor in some embodiments. It may be desirable to employ a mixture of POSS moieties with different molecular weight, different functional groups, or different oligomer/polymeric weight percentages in a single solution, or to combine different solutions comprising POSS of different molecular weights, different concentrations, and/or different chemistries (e.g., weight percent and/or types of functional groups) to achieve specific precursor properties such as viscosity, set time, storage stability and/or to provide certain properties to the resultant encapsulant such as thermal/optical stability, refractive index, and/or thermal conductivity.

Additional substances in the aforementioned neat POSS formulations or encapsulant precursors can be used, e.g., platinum catalyst, casting aids, defoamers, surface tension modifiers, functionalizing agents, adhesion promoters, crosslinking agents, other polymeric substances, substances capable of modifying the optical, thermal, rheological, and/or morphological attributes of the encapsulant precursor or resulting optical media or lens.

The concentration of POSS in the encapsulant precursor can be adjusted to provide a sufficient amount of weight percent POSS (as solids or liquid) as an encapsulant for a light emitter assembly and/or for forming an optical media, lens, etc, in proximity to one or more solid state light emitters. For example, the POSS-containing encapsulant precursor percentage of solids may be adjusted such that a sufficient amount of POSS is provided to the encapsulant that substantially prevents or reduces discoloration (yellowing) or other degradation of encapsulant by heat and/or optical intensity flux, or improves the index of refraction or thermal conductivity of the lens. In one aspect, a sufficient amount of POSS-containing LED encapsulant precursor would be an amount that substantially prevents or reduces discoloration or other degradation of encapsulant by heat or optical intensity flux by about 5 percent or more compared to a similar encapsulant without POSS. In another aspect, a sufficient amount of POSS-containing LED encapsulant precursor would be an amount that increases the index of refraction and/or the thermal conductivity of encapsulant compared to a similar encapsulant with or without POSS. While not limiting to any specific amount, the weight percent of POSS added to that of the encapsulant precursor useful for forming, e.g., an LED lens, of the embodiments disclosed herein is about 0.01 to about 80. In one aspect, the weight percent of POSS to that of the encapsulant precursor is between about 0.1 to about 10. In another aspect, the weight percent of POSS to that of the encapsulant precursor is about 1 to about 3 weight percent +/−0.5.

In one aspect, a curable encapsulant precursor alone or with other material can be used specifically for forming an optical medium and/or lens for a lighting device, including a solid-state lighting device, such as an LED device. The choice of encapsulant precursor and/or POSS-moiety can selected to achieve a matching coefficient of thermal expansion (CTE), or a predetermined index of refraction, or an optimal compatibility with phosphor and/or the POSS moieties.

### Light Emitters

Various embodiments of the present disclosure contemplate using the encapsulant precursor and/or resultant encapsulant for a lighting device having one or more light emitters. Light emitters can be any type light emitter (or any desired combination of light emitters). The light emitters can consist of a single color of light, or can comprise a plurality of sources of light which can be any combination of the same types of components and/or different types of light emitters, and which can be any combination of emitters that emit light of the same or similar wavelength(s) (or wavelength ranges), and/or of different wavelength(s) (or wavelength ranges).

The lighting device, emitters can comprise a solid state light emitter and a luminescent material, for example, a light emitting diode chip, in one aspect, a LED with a hemispherical transparent lens to cover the light emitting diode chip and provide light extraction, contacts to supply current to the light emitting diode chip, and thermal management from the component substrate to pull heat away from the chip. The luminescent material or phosphor (further discussed below) can be dispersed on the LED chip or remotely dispersed, e.g., in or on the lens, so as to be excited with the light that has been emitted from the light emitting diode (LED) chip.

In an exemplary embodiment, LEDs can be AlGaN and AlGaInN ultraviolet LED chips radiationally coupled to YAG-based or TAG-based yellow phosphor and/or group III nitride-based blue LED chips, such as GaN-based blue LED chips, are used together with a radiationally coupled YAG-based or TAG-based yellow phosphor. As another example, LEDs of group III-nitride-based blue LED chips and/or group-III nitride-based ultraviolet LED chips with a combination or mixture of red, green and orange phosphor can be used. Other combinations of LEDs and phosphors can be used in practicing the present disclosure.

As another example, the light source comprises LEDs of group III-nitride-based blue LED chips and/or group-III nitride-based ultraviolet LED chips with a combination or mixture of red, green and orange phosphor. In this case, the multi-phosphor material is excited by both UV and blue light emitted from the ultraviolet/blue LED chips and then mixture of red, green, orange light together with stray blue light can be mixed together providing a predetermined CCT value. Other combinations of LEDs and phosphors can be used in practicing the present disclosure.

### Lighting Devices

In certain aspects, the present disclosure comprises lighting devices including solid state light emitters as light sources which emit light of different colors which, when mixed, are perceived as the desired color for the output light (e.g., white or near-white). As discussed further below, the intensity of light emitted by many solid state light emitters, when supplied with a given current, can vary for a number of reasons as a result of temperature changes. The desire to maintain a relatively stable color of light output while providing sufficient heat transfer management is provided by the lighting device configuration of the present disclosure.

### Phosphors

The lighting devices described above and incorporating the encapsulant of the present disclosure can contain one or more phosphors. When phosphor particles are embedded into the encapsulant, for example a silicone encapsulant, which is a thick thermally insulating material, the phosphor grain temperature increases leading to an even lower quantum efficiency (QE) due to thermal quenching; this is a negative feedback effect, which is especially true in very small footprint packages. The presently disclosed encapsulant precursors comprising POSS moiety may provide a thermal path for the heat generated in the grains to be dissipated through the encapsulant/lens material of the present disclosure into ambient air, thereby resulting in higher conversion efficiency and less color shift over the lifetime of the lighting device.

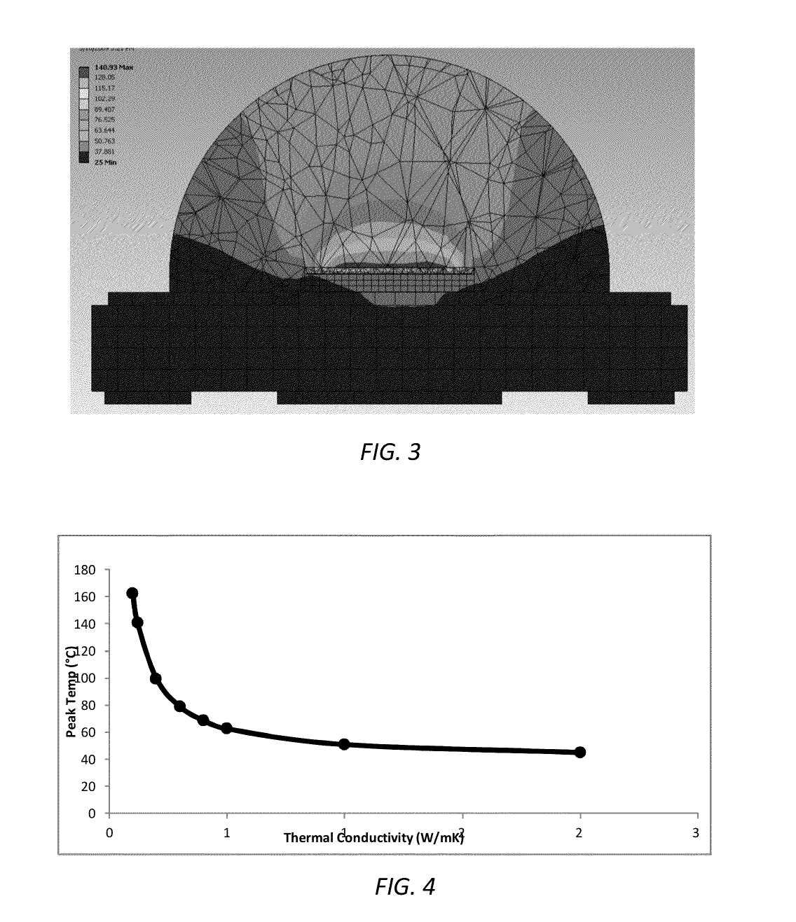

With reference to FIG. 3, a computer modeled heat distribution profile of an exemplary blue LED construct during operation with a 0.1 W/k thermal conductivity encapsulant (as a lens) and a phosphor binder is illustrated. FIG. 3 represents modeling of heat transfer throughout an encapsulant, the banding of shades of black and grey indicating relative temperature. FIG. 4 would suggest that providing improved thermal conductivity will lead to reduced temperature and/or temperature uniformity in the encapsulant and as a result, improve phosphor quantum efficiency. FIG. 4 shows the peak temperature in the LED component of FIG. 3 as a function of thermal conductivity of the lens and the phosphor binder. In addition, the better the heat dissipation, the less thermal droop of the blue LED's external quantum efficiency (EQE) as well as the phosphor quantum efficiency. For example, thermal efficiency of white-light producing LED devices can drop to 70 percent of its room temperature flux value at a junction temperature of 150° C. Providing any heat management functionality to the encapsulant material can extend the operating life and provide for more efficient and more stable lighting from the device.

Thus, in any one or more of the aforementioned encapsulant precursor embodiments, a phosphor can be added, incorporated therein, associated therewith, and/or combined. Phosphors include, for example, commercially available YAG:Ce, although a full range of broad yellow spectral emission is possible using conversion particles made of phosphors based on the (Gd,Y)₃(Al,Ga)₅O₁₂:Ce system, such as the Y₃Al₅O₁₂:Ce (YAG). Other yellow phosphors that can be used for white-light emitting LED chips include, for example: Tb₃-xREₓO₁₂:Ce(TAG), where RE is Y, Gd, La, Lu; or Sr_{2-x-y}BaₓCa_{y}SiO₄:Eu.

Some phosphors appropriate for these structures can comprise, for example: Red Lu₂O₃:Eu³⁺ (Sr₂₋ₓLaₓ)(Ce₁₋ₓEuₓ)O₄ Sr₂Ce₁₋ₓEuₓO₄ Sr₂₋ₓEuₓCeO₄ SrTiO₃:Pr³⁺,Ga³⁺ CaAlSiN₃:Eu²⁺ Sr₂Si₅N₈:Eu²⁺ as well as SrₓCa₁₋ₓS:EuY, where Y is halide; CaSiAlN₃:Eu; and/or Sr_{2-y}Ca_{y}SiO₄:Eu. Other phosphors can be used to create color emission by converting substantially all light to a particular color. For example, the following phosphors can be used to generate green light: SrGa₂S₄:Eu; Sr_{2-y}Ba_{y}SiO₄:Eu; or SrSi₂O₂N₂:Eu.

By way of example, each of the following phosphors exhibits excitation in the UV emission spectrum, provides a desirable peak emission, has efficient light conversion, and has acceptable Stokes shift, for example: Yellow/Green: (Sr,Ca,Ba)(Al,Ga)₂S₄:Eu²⁺ Ba₂(Mg,Zn)Si₂O₇:Eu²⁺Gd_{0.46}Sr_{0.31}Al_{1.23}OₓF_{1.38}:Eu²⁺_{0.06}(Ba_{1-x-y}SrₓCa_{y})SiO₄:Eu Ba₂SiO₄:Eu²⁺.

The lighting device can comprise solid-state light sources arranged with one or more phosphors so as to provide at least one of blue-shifted yellow (BSY), blue-shifted green (BSG), blue-shifted red (BSR), green-shifted red (GSR), and cyan-shifted red (CSR) light. Thus, for example, a blue LED with a yellow emitting phosphor radiationally coupled thereto and absorbing some of the blue light and emitting yellow light provides for a device having BSY light. Likewise, a blue LED with a green or red emitting phosphor radiationally coupled thereto and absorbing some of the blue light and emitting green or red light provides for devices having BSG or BSR light, respectively. A green LED with a red emitting phosphor radiationally coupled thereto and absorbing some of the green light and emitting red light provides for a device having GSR light. Likewise, a cyan LED with a red emitting phosphor radiationally coupled thereto and absorbing some of the cyan light and emitting red light provides for a device having CSR light.

The present disclosure and encapsulant precursors and encapsulant prepared therefrom provide a number of solutions to the aforementioned problems. First, the presently disclosed encapsulant precursors and resultant encapsulant provide for one or more of reduction of thermal degradation, reduction of optical degradation, reduction of thermal and optical degradation, and/or increase of index of refraction and/or thermal conductivity of encapsulant.

Second, the present disclosure and encapsulant precursors and encapsulant prepared therefrom can possibly provide an improved thermal path for the heat generated in the grains to be dissipated through the lens into ambient air, thereby resulting in higher conversion efficiency and less color shift over time.

Third, the present disclosure and encapsulant precursors and encapsulant prepared therefrom may provide an increase in refractive index of the encapsulant, and/or the optical transparency. Typically one is traded off the other in an effort to overcome thermal and/or optical flux degradation.

### Thermal/Optical Degradation Resistance

The presently disclosed POSS containing encapsulant precursors can provide optical and thermal properties more representative of an inorganic oxide material with the proccessability of an organic material. As a result, the presently disclosed POSS containing encapsulant precursors can provide a significant improvement in LED performance and reliability while using conventional LED fabrication methods. By way of example, the viscosity range of the presently disclosed POSS containing encapsulant precursors can be tailored so it is compatible with an existing encapsulant/lens composition and/or an existing encapsulating/lens fabrication process currently used for manufacturing lighting devices. For example, the curing time can be adjusted to facilitate incorporation into a high line throughput operation, for example by the selection of POSS and/or encapsulant precursor functional groups, weight percent loadings, molecular weights, platinum catalyst loading, etc., so as to mitigate factors such lens shrinkage and aging etc., and/or for providing component lifetimes of up to 100,000 hours or more. Other factors, such as POSS containing encapsulant precursor pot life (time after the initial catalysis to the time of gel formation), batch reproducibility, and shelf life can be adjusted, controlled, and monitored using conventional methods to provide robust manufacturability.

Thermal and optical stability are not fully independent, for example, a conventional silicone encapsulant material can readily withstand exposure to 150° C. conditions for extended periods of time, however, the same is not necessarily true when the conventional silicone encapsulant is subjected to 150° C. and simultaneously, high optical flux densities. There is no available evidence concerning the effect of POSS incorporation on the resistance of materials to high optical flux densities. The ionic-covalent nature of the POSS moiety is capable of improving the optical stability and the thermal stability of conventional encapsulants. This enhanced optical stability together with thermal stability enhancement will provide LED devices capable of operation at higher optical flux densities for extending duration at typical operating temperatures (from about room temperature to 150 degrees Centigrade or higher) with improved luminous output. Thus, by incorporating POSS moieties and/or reactive POSS moieties to optical quality encapsulant/encapsulant precursors, it is observed that the long-term performance attributes of the encapsulant or lens can be improved. The improvement includes, for example, stability against high temperatures and/or optical fluxes, increased thermal conductivities and increased refractive indices. While not to held to any one theory, it is believed that POSS moieties, which possess a compact, cage-like structure comprised of silicon-oxygen-silicon (Si—O—Si) bonds, in effect, provide a polyhedral unit as a “building block” of silica that can be chemically and/or physically incorporated into an encapsulating matrix, such as a silicone, epoxy resin, etc. Silicone materials currently used as encapsulants are typically comprised of a linear Si—O—Si backbone, e.g., PDMS). However, the network connectivity of most POSS materials is three-dimensional instead of linear, thereby imparting significant chemical, thermal, and mechanical stability. The corners of the polyhedral unit are capped with functional groups that serve as linkages to graft the POSS to existing siloxane chains or smaller oligomeric precursors to create modified silicones—in this case, the silicone material used to fabricate the encapsulant component. Thus, methods of improving the performance and lifetime of an encapsulant or lens by providing an encapsulant precursor comprising at least one POSS moiety are provided. The method can further provide for improved thermal degradation, improved optical flux degradation, improved thermal and optical flux degradation. In other aspects, the method provides for increased thermal conductivity and/or increased refractive index for the finished encapsulant. Such instantly disclosed improvements provide for performance and reliability of LED devices at levels that cannot be achieved using conventional encapsulant precursors alone.

In addition, while not bound by any particular theory, it is believed that a combination of vinyl-containing POSS moieties and platinum metal (either as dispersed particles or organometallic compounds thereof) assist and or synergistically contribute to the improved optical/thermal stability, as evidenced by measured low UV absorbance increase over time at elevated temperatures and high optical flux densities of specific encapsulants with POSS moieties. Thus, in one aspect, a method of reducing thermal degradation and/or optical degradation of an encapsulant exposed to elevated temperature and high optical flux densities is provided by having a predetermined molar or mass ratio of vinyl-POSS moiety to platinum metal or platinum compound of between about 0.001:1 to about 100:1.

### Thermal Conductivity Improvement

The thermal conductivity of existing encapsulants, such as, but not limited to silicones, used as optical media/encapsulant/lens for LED's, can impact the efficiency of the phosphor down conversion process, and as a result, affect the performance of white-light producing LED devices. For example, because the phosphor layer is placed over the blue LED chip, it can only be as cool as the chip, which acts as a heat sink for the phosphor. While the phosphor's quantum efficiency can be high at room temperature (>90 percent), it decreases rapidly with attainment of the operating temperature of the LED due to the thermal quenching effect or thermally activated concentration quenching. This heating also results in a white color point shift. Both the quenching and color point shift are undesirable for longevity of LED's as replacements for conventional Edison-like lights, for example. In addition, the phosphor generates significant heat itself due to the fundamental Stokes loss from the down-conversion of light (about 25-30 percent at 2,700-3,000 K CCT).

The thermal conductivity (k) of the encapsulant is a significant factor in heat management, since heat must be dissipated away from the phosphor particles and the LED chip as readily as possible (e.g., as shown in FIG. 4). Phosphor particles embedded within low k materials such as silicone encapsulants (k˜0.15 to 0.2 W/mK) undergo significant heating under high optical flux densities emitted by, for example, a GaN chip. Increased heating decreases the quantum efficiency of the phosphors, thereby reducing the overall LED package efficiency. The instant encapsulant precursors with functionalized POSS moiety can provide an increased k value for the resultant encapsulant so as to provide for improved heat dissipation in high optical flux LED devices.

Based on a simple “rule of mixtures” approach, the incorporation of a higher k material (e.g., POSS) into a low k, e.g., silicone encapsulant, is expected to increase the effective k of the composite. However, this approach does not consider the particle size of the discontinuous POSS being used to increase k. The effective k of the overall encapsulant precursor is likely dependent on a number of parameters, including but not limited to: the k of the silicone phase, the k of the POSS phase, the amount and type of chemical functionality and its degree of incorporation in the POSS moiety, the volume fraction of the POSS phase, the effective radius of the discontinuous POSS phase, and the thermal conductive of the POSS/silicone interface. The k of SiO₂ is approximately one order of magnitude higher than a typical silicone polymer, which suggests that the incorporation of silica particles within a silicone matrix can potentially increase the k of the combination relative to pure silicone, whereas published results indicated thermal conductivity values as high as 0.35 W/m-K for SiO₂/silicone mixtures. However, the particle size of the discontinuous inorganic particle phase is also determinative of its impact on the effective k of the composite. That said, the incorporation of inorganic POSS into the organic silicone phase may increase or decrease k of the resultant encapsulant. If the POSS structural unit is regarded as essentially the smallest possible stable particle of SiO₂, and this size of the POSS structural unit is significantly smaller than the critical radius “rₒ” that serves as a threshold for determining the effect of particles on the effective k of a composite, then particles that are smaller than r_{c}, can decrease the effective k of the composite. Typical rₒ values for metal oxide nanopartices dispersed within a polymer matrix are on the order of 10 nm, although no published values specifically for SiO₂ within a silicone matrix, or that of a POSS moiety are known.

### Index of Refraction Increase

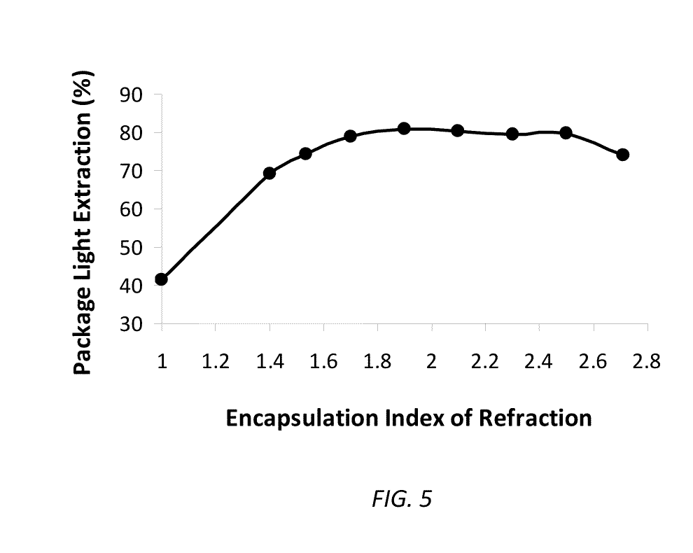

Optical transparency and refractive index are two important properties to create a high efficacy LED package. A higher refractive index encapsulant material is in fact more desirable, owing to enhanced light extraction from the device, as shown in FIG. 5. FIG. 5 represents graphically the package light extraction percent as a function of the encapsulant index of refraction. Optical transparency of certain encapsulants, for example, silicone, can be rather high, at about 94 percent (including Fresnel losses). However, as mentioned above, at least one optical limitation with current silicone technology is its refractive index, which is generally centered around 1.4 to about 1.55, with silicones having higher refractive indexes generally having non-optimal reliability performance when exposed to high optical flux densities. While not to be held to any theory, such non-optimal reliability performance of high index silicones is likely due to the chemical composition, molecular arrangement and the presence of higher refractive index chemical moieties, such as phenyl groups.

While silicone materials with a refractive index of about 1.4 can provide reasonable reliability under the flux densities of current lighting class emitters, an increase in refractive index of the encapsulant material would enhance the light extraction efficiency and should improve the LED efficacy, e.g. as shown in FIG. 5, a refractive index increase from about 1.4 to about 1.7 can increase efficiency about 5-10 percent. The POSS moieties in combination with encapsulant precursor provide for the capability of increasing the refractive index of encapsulants, e.g., by their addition to conventional encapsulants, in particular, silicone encapsulants. The higher refractive index that would be possible with the POSS-containing phosphor-encapsulant or scatter-encapsulant coating applied to a remote optic would also reduce Fresnel losses by allowing more light to escape, increasing conversion efficiencies.

Optical transparency is highly linked to the organic functionalities present in the POSS moiety. Purely inorganic silica is renowned for its optical transparency. POSS moieties are effectively a discrete unit of a SiO₂-metal that should possess modified optical properties, but likely modified to some extent as a function and/or concentration of the organic capping groups. By way of example, conventional silicone encapsulants typically have optical transparency of 94% (including Fresnel losses). Therefore, the individual organic and inorganic phases as elements to create the nanocomposite material can provide an equivalent transparency. Furthermore, assuming adequate dispersion within the silicone matrix, the nanoscale size of the POSS moiety should prevent Rayleigh scattering due to regions of varying refractive index.

It is understood that such POSS moieties and/or physical mixtures or reaction products of a POSS moiety with optical media or encapsulant precursors are preferably transparent to the light emitted by the lighting device, in other words, the disclosed materials and optical media is clear and/or of an optical clarity suitable for use with a lighting device producing visible light.

The incorporation POSS into a siloxane network can increase the refractive index of the encapsulant when used in combination with POSS moieties having suitable functionality. In one aspect, a POSS moiety can provide for a refractive index of greater than 1.5, greater than 1.52, greater than 1.53. The POSS moiety can be functionalized as any of the POSS compounds described above.

In one aspect, alone or in combination with the POSS described above, the addition of a predetermined amount of transition metal oxide species, such as anatase and/or rutile forms of titania (TiO₂; refractive indices of 2.5 and 2.9 respectively), can be employed to adjust the refractive index, and perhaps even enhance the refractive properties of an encapsulant containing POSS moiety. Alternately, the effective refractive index of encapsulant prepared by the methods herein disclosed may be increased by physically blending in TiO₂ at a level that does not otherwise effect the transparency or optical transmission of the optical media/encapsulant. In one aspect, nanoparticles of TiO₂ can be used for reducing or eliminating reflection of visible light.

The presently disclosed POSS containing encapsulant precursors can provide optical and thermal properties more representative of an inorganic oxide material with the proccessability of an organic material. As a result, the presently disclosed POSS containing encapsulant precursors can provide a significant improvement in LED performance and reliability while using conventional LED fabrication methods. By way of example, the viscosity range of the presently disclosed POSS containing encapsulant precursors can be tailored so it is compatible with an existing encapsulant/lens composition and/or an existing encapsulating/lens fabrication process currently used for manufacturing lighting devices. For example, the curing time can be adjusted to facilitate incorporation into a high line throughput operation, for example by the selection of POSS and/or encapsulant precursor functional groups, weight percent loadings, molecular weights, metal, platinum catalyst loading, etc., so as to mitigate factors such lens shrinkage and aging etc., and/or for providing component lifetimes of about 100,000 hours or more. Other factors, such as POSS containing encapsulant precursor pot life (time after the initial catalysis to the time of gel formation), batch reproducibility, and shelf life can be adjusted, controlled, and monitored using conventional methods to provide robust manufacturability.

Incorporation of POSS moiety to encapsulant precursor can also provide an increase in viscosity to the material, and/or facilitate curing and/or increase cure time, thus increasing manufacturing throughput. Volumetric shrinkage of the POSS moiety and encapsulant precursor is highly dependent on the organic functionalities and solvent content present. In some aspects, xylene solvent can be used to provide mixing of the POSS with one or more of the encapsulant precursors. In general, low solvent contents will reduce shrinkage during encapsulation/lens fabrication. The specific POSS/encapsulant precursor combination useful for fabricating encapsulant/lenses can be possible with little or no additional solvent, thereby reducing volumetric shrinkage and/or warping, and eliminating the formation of significant porosity of encapsulant.

Forming Optical Media and/or Optical Lens

The LED encapsulant precursor may be sprayed, cast, coated, deposited, or dipped in proximity to, directly to, or on the lighting device, in particular the light emitters, LEDs, or LED assembly. The dispensing of the encapsulant precursor may be performed using any known dispensing technique. In one aspect, two, three or more layers of encapsulant precursor may be formed by the sequential application, curing and/or drying. The encapsulant precursor, or a solvent containing same, can be used and/or heated to facilitate flow of the encapsulant precursor, for example, into a mold. The encapsulant precursor may be used to provide an encapsulating layer and/or lens of any desired height, width, length, or diameter.

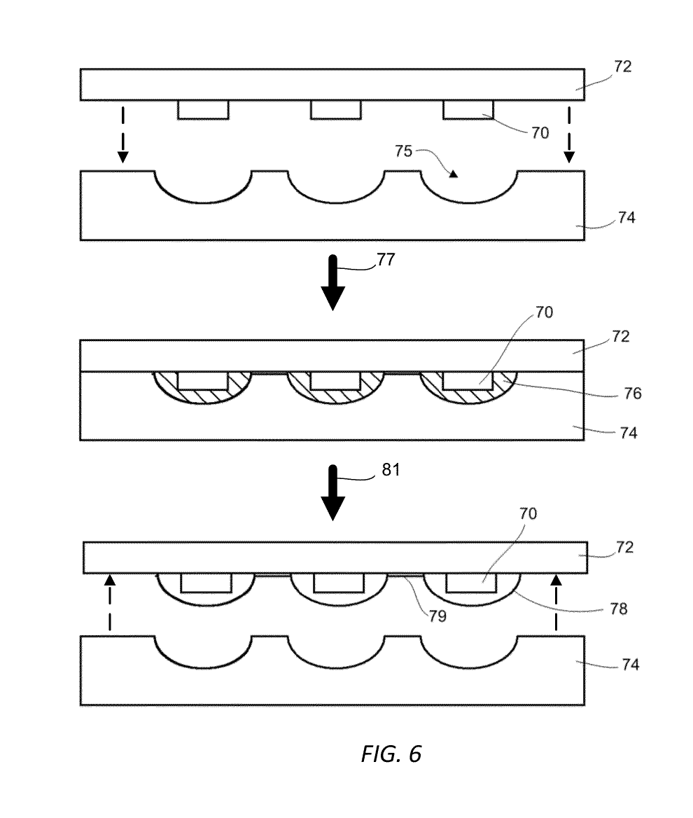

FIG. 6 presents an exemplary process schematic for providing an optical lens material comprising an encapsulant having at least one functionalized POSS moiety, whereas a side view of a plurality of LEDs 70 are shown mounted on a support substrate 72. Support substrate 72 can be any type of submount, a printed circuit board, a heat sink, or another structure.

Mold 74 as shown has predetermined indentations 75 of a size corresponding to the desired shape of intended lens 78 positioned over, about, or around one or more of LEDs 70. Mold 74 can be constructed of any material capable of releasing the encapsulant precursor after curing. In one aspect, mold is a metal or alternatively, a metal having a coating, such as Teflon, or other releasing film, coating, placed or formed over or in the metal mold, and/or the metal can be pre-treated with a material to aid in releasing the finished lens and/or that prevents sticking of the resultant encapsulant.

Referring still to FIG. 6, mold indentions 75 are filled with a curable encapsulant precursor 76 comprising at least one functionalized POSS or poly-POSS moiety. In one aspect encapsulant precursor 76 is a liquid capable of flowing into mold indentations 75 or being urged into the indentations by pressure or vacuum.

In one exemplary process, a vacuum seal is provided between support structure 72 and mold 74. Support structure 72 with LEDs 70 and mold are then pressed against each other under a compression force as illustrated by step 77. Encapsulant precursor 76 is inserted into the volume between support structure 72 and mold 74. Mold 74 can, if desired, be heated to a predetermined temperature for a predetermined time so as to cure and/or harden encapsulant precursor 76 into an encapsulant 78, such as an optical media or lens. Separately or in combination, layer 79 can be formed between LEDs 70, for example, using encapsulant precursor 76 with added scatter to provide light scattering. Phosphor and other material can be added to encapsulant precursor 76.

After the predetermined time at the predetermined temperature, the support structure is then separated from mold as illustrated in step 81. In one aspect, a cooling of the components is carried out before separation. If a releasing film is used, it is removed and LED 70 with encapsulant 78, shown as an optical lens, can be removed from mold 74. Encapsulant 78 is shown in proximity to the LED and/or in optical communication with the light emitted by the LED.

In another embodiment, additional layers and/or phosphors are employed on LEDs 70 prior to the introduction of the lens-forming precursor. Thus, for example, the LEDs can be first covered with a material and/or layer, such as phosphor in a binder (the binder can be a curable silicone). In this embodiment, after one or more of LEDs 70 are covered and/or layered, encapsulant precursor 76 can be introduced into volume between support structure 72 and mold 74, filling mold indentations 75, as discussed above, so as to form the lens over the covered/layered LEDs.

### Examples

Encapsulant precursor compositions comprising POSS was prepared, by way of example, by adjusting one or both of the part A and part B ratios of a silicone encapsulant, in order to adjust for additional functional groups introduced by the POSS. By way of example, using a conventional silicone (Part A/Part B) part A was reduced (i.e. less catalyst), from a standard A/B ratio of 0.25 (1/4), to about 0.15 (or about 1/6.7) with the addition of octavinyl POSS.

A control encapsulant material used was obtained commercially and was believed to consist of a two part optical silicone having mostly in Part A methylphenyl siloxane, dimethylvinylsiloxyl-terminated silicone resin, and having in Part B a proprietary mixture of silsesquioxane and polysiloxanes, according to the manufacturer's Material Safety Data Sheet (MSDS). Thus, the control encapsulant precursor Part A contained a catalyst and Si-vinyl groups, while Part B comprised silyl groups for crosslinking with Part A. A control sample was prepared by first mixing one part Part A and four parts Part B (hereinafter “the control”) and placing the mixture in a vacuum for 2 hours.

Embodiments of the present disclosure were made by adding functionalized POSS to the control. Typically, the POSS was dissolved in a selected solvent suitable for dissolving the POSS and being miscible with the combined Part A and Part B. For example, octavinyl POSS dissolved at a rate of 0.2 g into 3 ml of THF, which was filtered through 7 micron Whatman filter paper, and added to the mixed Part A/Part B control at the end of its 2 hour vacuum period. The sample solution was returned to the vacuum and re-evacuated for more than 30 minutes to remove the solvent, after which the samples were allowed to crosslink at 120° C. overnight at that temperature.

The control without functionalized POSS was reheated at 165° C. for 1 hour to compensate for the additional heating of the samples. An octavinyldimethyl POSS sample was prepared in a similar manner, which was mixed using the same method although it was observed that additional octavinyldimethyl POSS could be added, thus, the ratio of the material to solvent was increased. Samples comprising mono-vinyl isobutyl POSS were prepared in a similar manner. Samples comprising norbornenyl POSS were mixed with the control as received, as they were liquid at room temperature and appeared to mix completely with the control.

Attempts were made to balance the addition or removal of double bonds and/or silyl functional groups present in the POSS moieties with changes in the weight ratios of Part A and Part B. Thus, samples comprising octasilane POSS were dissolved in xylene (about 0.2 grams of POSS to 1.5 ml of xylene) with about 1 drop of catalyst (about 0.05 mL of 1/20th solution of the 4500 system catalyst (platinum-cyclovinylmethyl siloxane complex in cyclovinylmethylsiloxanes (Sip 6832 from Gelest) was added as well as a drop (about 0.05 mL) vinyldimethylsilane (Gelest) to the control. Up to 1.5 weight percent of the octasilane material could be added without precipitation.

Sample batches totaling about 10 grams in weight were used to make optical slides which consisted of 4.67 mm thick samples of silicone sandwiched between 2 glass microscope slides (Fisher premium catalog number 12-544-1). These samples were used for UV-Vis measurements. Leftover material was cured in an aluminum pan and used for Shore hardness, thermal expansion, thermal conductivity, refractive index, and other property measurements as needed.

The coefficient of thermal expansion was measured on a dual pushrod Theta dilatometer without a force control, so typically the expansion did not begin until 50-100 C, and expansion was measured above that temperature. This delay does not occur in ceramics and is a result of the physical properties of the silicone rubber matrix.

Index of refraction was measured using an Abbe refractometer (Leica Mark II) at the sodium D-line. Long term thermal testing of the control and the samples with added POSS was performed in an electric oven set at 170° C.

The UV-Vis spectrum was measured in a Lambda 950 from Perkin Elmer. This dual beam instrument is zeroed at the beginning of each data set. The solid sample holder was used. The transmission was measured from 800-250 nm with 2 mm slit width. The 4.65 mm samples sandwiched between two glass slides, described above, were used. Over most of the visible range, absorption for the control and the samples was not really detectable by this instrument, only the yellowing after heat treatment was detected and recorded.

### Experimental Results

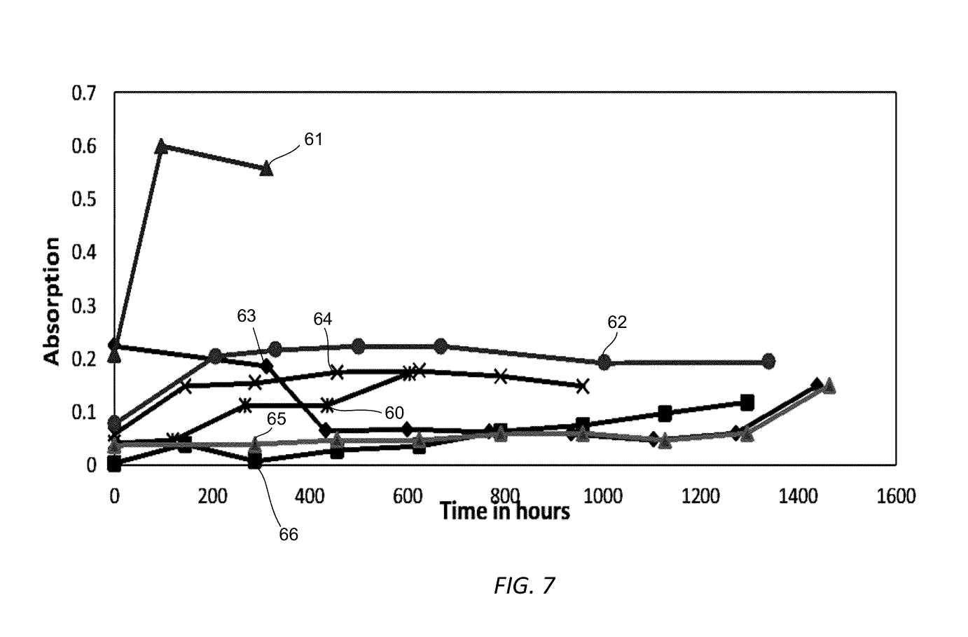

Using specific functional groups on the POSS moiety in combination with an encapsulant precursor can impact positively or negatively the resultant encapsulant properties. With reference to FIG. 7, a conventional silicone encapsulant (“control”) provided a UV absorbance profile, as determined and depicted by curve 60. The yellowing is determined by subtracting the absorption at 700 nm (essentially the baseline) from the absorption at 442 nm. This additional absorption was considered to be a measure of yellowing. In some samples that appeared very yellow the absorption band extended to 700 nm. A mono vinyl-functionalized POSS (where vinyl is norbornyl; R is isobutyl; NB1021 Hybrid Plastics) was used to create an optical grade encapsulant and was subjected to heat aging at 170 degrees Centigrade and its UV absorbance at about 424 nanometers measured at discrete time intervals. As shown in FIG. 7, this mono-functional vinyl POSS (curve 61) showed severe yellowing at 170° C. after a few hundred hours of aging (without optical flux exposure). Thus, with reference to FIG. 7, curve 61, which represents the aforementioned POSS moiety with one relatively reactive vinyl group and multiple relatively un-reactive aliphatic isobutyl groups, little if any improvement of resistance to yellowing of the control encapsulant was observed, as indicated as an increase in absorbance of curve 61 relative to the other samples.

In contrast, as shown in FIG. 7, POSS moieties comprising multiple vinyl groups represented by curve 63 [octavinyl-POSS 2 weight percent; OL1160 Hybrid Plastics] and curves 65 and 66 [octavinyl-POSS 1 weight percent; OL1160 Hybrid Plastics] provided an reduction in thermal degradation of the control encapsulant. POSS moieties comprising multiple hydride chemical groups, represented by curves 62 and 64 [octasilyl-POSS@1.2 weight percent; SH1311 Hybrid Plastics] where observed to be similar to that of the control initially, and appeared to provide long-term performance relative to the control (not shown). It was noted that the octasilyl POSS sample represented by curve 62 contained additional platinum catalyst, which may have contributed to some yellowing. Curve 64 represents a sample from a different batch than that providing curve 62. Curve 66 from FIG. 7 represents a repeat run of the sample providing curve 63 (octavinyl POSS at 2 weight percent), both of which showed some variability in the response initially, however, long-term performance was more consistent and the variability was tolerable. Surprisingly, adding the octavinyl POSS to the control provided improved heat and light aging properties and resistance to yellowing, whereas the mono-vinyl POSS added to the control did not appreciably improve the resistance to yellowing. Thus, the functionalized POSS added to the control did not directly correlate with resistance to yellowing, regardless of other improvements obtained.

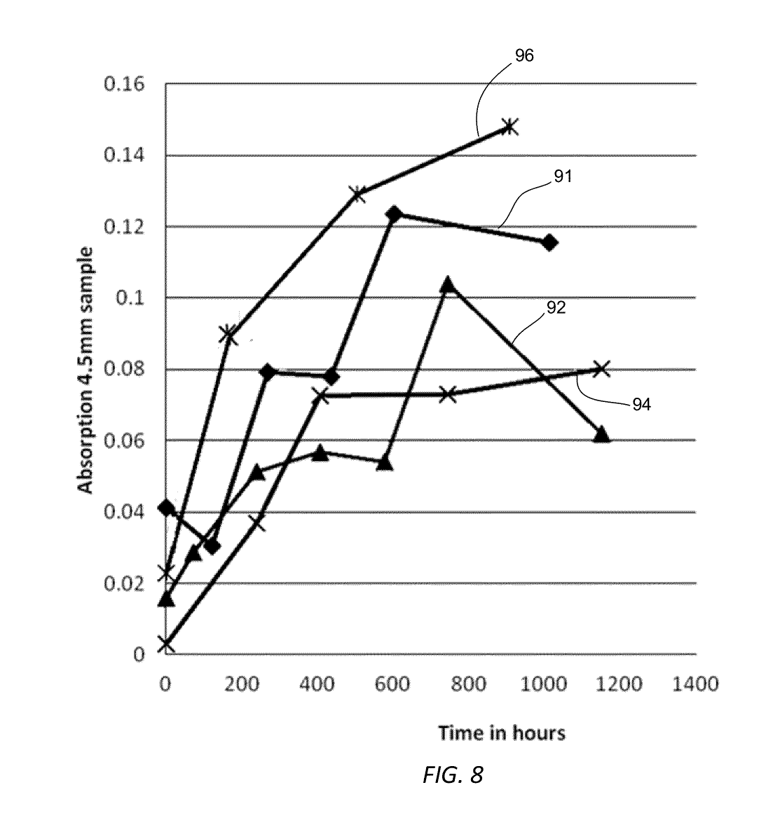

FIG. 8 depicts experimentally determined yellowing of optical media compositions comprising POSS moieties at conditions described above. The compositions comprise varying weight percent added functionalized POSS material having multi-vinyl functionality, e.g., octavinyl dimethyl POSS [OL1163; Hybrid Plastics], which when added to the control, aged at 170 degrees Centigrade for up to 168 h, provided improved yellowing-resistance within a defined range. Thus, octavinyl dimethly POSS with 1 weight percent, represented by curve 92, and 2 weight percent octavinyl dimethyl POSS, represented by curve 94, respectively, appear to reduce the yellowing, while a 4 weight percent loading of octavinyl dimethyl POSS, as represented by curve 96, appears to be the same as that of the Control, represented by curve 91, respectively. Thus, the amount of functionalized POSS sufficient to provide improved resistance to thermal and/or optical degradation, including resistance to yellowing, appears to fall into a predetermined range dependent on the nature of the POSS functional group and the compositional make-up of the matrix.

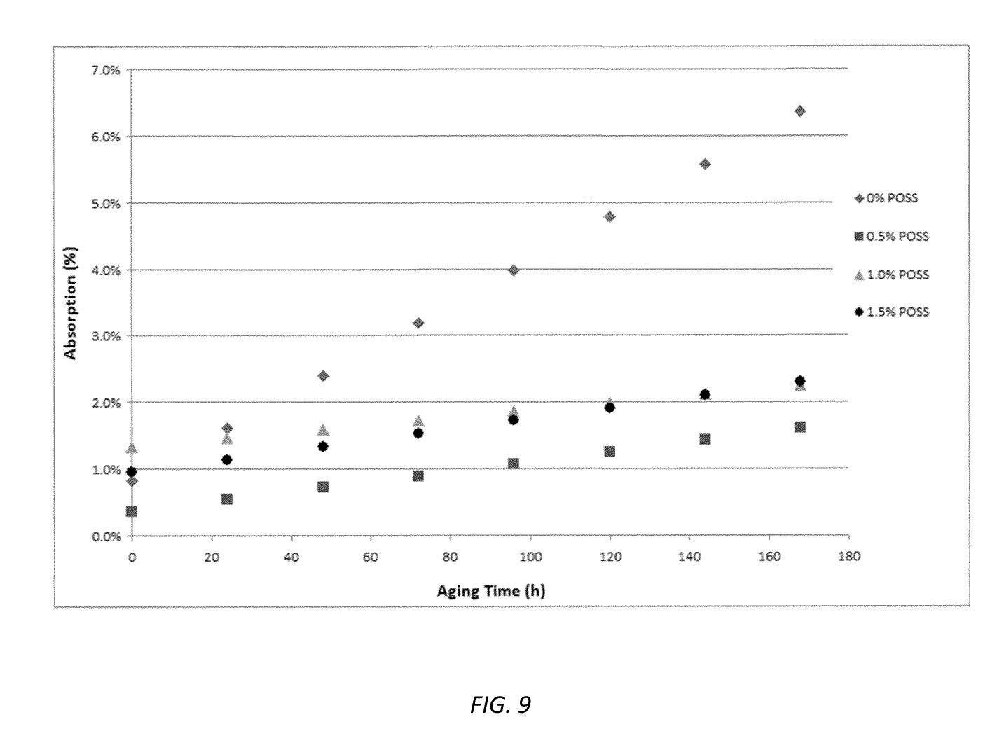

FIG. 9 represents molded silicone optical media test samples aged at 170 degrees Centigrade for up to 168 h. The results show the thermal stability benefit of added 0.5, 1.0 and 1.5 weight percent octavinyl POSS [OL1160 Hybrid Plastics] when compared with the control silicone optical media alone (0% POSS). For this data, the control precursor components were adjusted: part A and part B ratios of the silicone (part A having the Pt catalyst), to adjust for the additional vinyl groups of the octavinyl POSS in the system. While the amount of catalyst and the amount of vinyl groups present in the control, part A was reduced (i.e. less catalyst), by adjusting the standard A/B ratio from 0.25 (1/4), to 0.15 (^{˜}1/6.7) with the addition of octavinyl POSS to Part A. The data of FIG. 9 was fitted to a linear trendline. The data of FIG. 9 represents different tests conducted at different times, and represents sets of data that were repeated to obtain an average trend.

Thus, the data in FIGS. 7, 8, and 9 demonstrate the thermal stability benefit of added functionalized POSS to an optical media, especially when compared with the control (0 weight percent added POSS).

All references cited herein, including but not limited to published and unpublished applications, patents, and literature references, are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

All numbers expressing quantities of ingredients, reaction conditions, and so forth used in the specification may be to be understood as being modified in all instances by the term “about.” Accordingly, unless indicated to the contrary, the numerical parameters set forth herein may be approximations that may vary depending upon the desired properties sought to be obtained. At the very least, each numerical parameter should be construed in light of the number of significant digits and ordinary rounding approaches.

The present disclosure is applicable to lighting devices of any size or shape capable of incorporating the described POSS encapsulant, including flood lights, spot lights, and all other general residential or commercial illumination products. For example, the POSS encapsulant embodiments presently disclosed are generally applicable to a variety of existing lighting packages, for example, XLamp products XT-E, XB-D, MT-G, CXA-2011, XM-L, ML-B, ML-E, MP-L EasyWhite, MX-3, MX-6, XP-G, XP-E, XP-C, MC-E, XR-E, XR-C, and XR LED packages manufactured by Cree, Inc.

The above description discloses several methods and materials. These descriptions are susceptible to modifications in the methods and materials, as well as alterations in the fabrication methods and equipment. Such modifications will become apparent to those skilled in the art from a consideration of this disclosure or practice of the disclosure. Consequently, it is not intended that this disclosure be limited to the specific embodiments disclosed herein, but that it cover all modifications and alternatives coming within the true scope and spirit of the claims.

What is claimed is:

1. A light emitting device comprising:
at least one light emitter; and
an encapsulant in proximity to the at least one light emitter, the encapsulant comprising at least one functionalized polyhedral oligomeric silsesquioxane and/or at least one functionalized polysilsesquioxane.

2. A light emitting device of claim 1, wherein the at least one functionalized polyhedral oligomeric silsesquioxane and/or the at least one functionalized polysilsesquioxane comprises an open cage, partially condensed silsesquioxane, a closed cage, fully condensed silsesquioxane, or mixtures thereof.

3. A light emitting device of claim 1, wherein the functionalized polyhedral oligomeric silsesquioxane and/or the functionalized polysilsesquioxane further comprises at least one of a C₁₋₁₈ alkyl and/or a C₆₋₆₀ aryl functional group.

4. A light emitting device of claim 1, wherein the functionalized polyhedral oligomeric silsesquioxane and/or the functionalized polysilsesquioxane comprises at least one of a vinyl, a phenyl, a silyl, and/or an aryl functional group.

5. A light emitting device of claim 3, wherein the functionalized polyhedral oligomeric silsesquioxane and/or the functionalized polysilsesquioxane comprises a vinyl and/or a silyl functional group.

6. A light emitting device of claim 3, wherein the functionalized polyhedral oligomeric silsesquioxane and/or the functionalized polysilsesquioxane comprises at least one chemically reacted group derived from at least one of vinyl, styrenyl, thiol, amine, silyl, siloxy, epoxide, methacryl, acryl, methacrylamidyl, acrylamidyl, nitrile, isocyanate, isothiocyanate, carboxyl, hydroxyl, and norbornenyl.

7. A light emitting device of claim 1, wherein the encapsulant further comprises a matrix selected from polysilicones, polydialklysiloxanes, polyalkylaryl siloxanes and/or polydiarylsiloxanes), epoxy resins, polyesters, polyarylesters, polyurethanes, cyclic olefinic copolymers (COC's), polynorbornenes, and/or copolymers thereof.

8. A light emitting device of claim 7, wherein the at least one functionalized polyhedral oligomeric silsesquioxane and/or at least one functionalized polysilsesquioxane dispersed or distributed in the matrix.

9. A light emitting device of claim 1, wherein the encapsulant comprises a mixture or reaction product of:
(i) at least one polyhedral oligomeric silsesquioxane and/or at least one polysilsesquioxane comprising at least one function group selected from: silyl, vinyl, styrenyl, thiol, amine, siloxy, epoxide, methacryl, acryl, methacrylamidyl, acrylamidyl, nitrile, isocyanate, isothiocyanate, carboxyl, hydroxyl, and norbornenyl; and
(ii) a matrix selected from at least one polymer or oligomer of polydialklysiloxanes, polyalkylaryl siloxanes, and polydiarylsiloxanes, and comprising at least one silyl, hydroxy, alkoxy, amine, chlorine, epoxide, isocyanate, isothiocyanate, nitrile, vinyl, thiol, acrylate, methacrylate, acrylamide, methacrylamide, fumarate, maleate, norbornenyl and styrene functional groups.

10. A light emitting device of claim 1, wherein the encapsulant comprises a mixture or reaction product of:
(i) a polyhedral oligomeric silsesquioxane or a polysilsesquioxane comprising at least one function group selected from: vinyl, or silyl; and
(ii) a matrix selected from at least one polymer or oligomer of polydialklysiloxanes, polyalkylaryl siloxanes, and polydiarylsiloxanes, and comprising at least one of vinyl-, silyl-, and/or hydroxyl-containing functional groups.

11. A light emitting device of claim 1, wherein the encapsulant comprises a mixture or reaction product of:
(i) at least one of trishydroxy phenyl-POSS, trishydroxy ethyl-POSS, trishydroxy phenyl-POSS, octadimethylhydrosilyl-POSS, octavinyl-POSS and octavinyldimethylsilyl-POSS; and
(ii) a matrix selected from at least one polymer or oligomer of polydialklysiloxanes, polyalkylaryl siloxanes, and polydiarylsiloxanes, and comprising vinyl-, silyl-, and/or hydroxyl-containing functional groups.

12. A light emitting device of claim 1, wherein the encapsulant comprises at least one of: poly(propylmethacryl POSS-co-methylmethacrylate) and/or poly(propylmethacryl POSS-co-styrene); poly(1-methoxy-4-(3-propyloxy-heptaisobutyl-POSS)-2,5-phenylenevinylene)-co-(1-methoxy-4-(2-ethylhexyloxy)-2,5-phenylenevinylene) (60:40 mole:mole); poly[(propylmethacryl-heptaisobutyl-POSS)-co-(t-butyl methacrylate)] POSS; poly[(propylmethacryl-heptaisobutyl-POSS)-co-(methyl methacrylate)] POSS; poly[(propylmethacryl-heptaisobutyl-POSS)-co-(n-butyl methacrylate)] POSS; poly[(propylmethacryl-heptaisobutyl-POSS)-co-hydroxyethyl methacrylate] POSS; poly[(propylmethacryl-heptaisobutyl-POSS)-co-styrene] POSS; poly[1-methoxy-4-(3-propyloxy-heptaisobutyl-POSS)-2,5-phenylenevinylene]; and poly[1-methoxy-4-(3-propyloxy-heptaisobutyl-POSS)-2,5-phenylenevinylene]-co-[1-methoxy-4-(2-ethylhexyloxy)-2,5-phenylenevinylene] (30:70 mole:mole).

13. A light emitting device of claim 1, wherein the lighting device comprises at least one solid state light emitter.

14. A light emitting device of claim 1, further comprising a phosphor.

15. A light emitting diode (LED) device comprising
a support having at least one LED thereon; and
a mixture or reaction product of (i) at least one functionalized polyhedral oligomeric silsesquioxane and/or at least one functionalized polysilsesquioxane, and comprising at least one functional group, the mixture or reaction product capable of forming an optical media deposited on the LED and/or the support; and (ii) optionally, a catalyst.

16. A light emitting diode device of claim 15, wherein the functionalized polyhedral oligomeric silsesquioxane and/or the functionalized polysilsesquioxane comprises an open cage, partially condensed silsesquioxane, a closed cage, fully condensed silsesquioxane, or mixtures thereof.

17. A light emitting device of claim 15, wherein the mixture or reaction product further comprises a matrix material selected from at least one polymer or oligomer of polysilicones, polydialklysiloxanes, polyalkylaryl siloxanes, polydiarylsiloxane, epoxy resins, polyesters, polyarylesters, polyurethanes, cyclic olefinic copolymers (COC's), polynorbornenes, or combinations thereof.

18. A light emitting device of claim 17, wherein the matrix material comprises one or more functional groups capable of curing or crosslinking with the at least one functionalized polyhedral oligomeric silsesquioxane and/or at least one functionalized polysilsesquioxane.

19. A light emitting device of claim 15, wherein the optical media is formed by crosslinking a mixture of:
(i) a functionalized polyhedral oligomeric silsesquioxane and/or a functionalized polysilsesquioxane; wherein the functional group is one or more of: silyl, hydroxy, alkoxy, amine, chlorine, epoxide, isocyanate, methacrylate, acrylate, methacrylamide, acrylamide, nitrile, isocyanate, isothiocyanate, norbornenyl, vinyl, styrenyl, or thiol;
(ii) a matrix selected from at least one polymer or oligomer of polydialklysiloxanes, polyalkylaryl siloxanes, and polydiarylsiloxanes, the matrix comprising at least one silyl, hydroxy, alkoxy, amine, chlorine, epoxide, isocyanate, isothiocyanate, nitrile, vinyl and thiol, acrylate, methacrylate, acrylamide, methacrylamide, fumarate, maleate, norbornenyl and styrene functional groups; and
optionally, a catalyst.

20. A light emitting device of claim 15, wherein optical media is formed by a mixture or a reaction product of:
(i) at least one of trishydroxy phenyl-POSS, trishydroxy ethyl-POSS, trishydroxy phenyl-POSS, octadimethylhydrosilyl-POSS, octavinyl-POSS and/or octavinyldimethylsilyl-POSS;
(ii) a matrix selected from at least one polymer or oligomer of polydialklysiloxanes, polyalkylaryl siloxanes, and/or polydiarylsiloxanes, the matrix comprising at least one of vinyl-, silyl-, and/or hydroxyl-containing functional groups; and
a catalyst.

21. A method of reducing degradation of an encapsulant of a lighting device, the method comprising:
forming an encapsulant configurable for a lighting device, the encapsulant comprising at least one functionalized polyhedral oligomeric silsesquioxane and/or at least one functionalized polysilsesquioxane present in an amount sufficient to reduce degradation of the encapsulant during operation of the lighting device.

22. A method of claim 21, wherein the one functionalized polyhedral oligomeric silsesquioxane and/or the at least one functionalized polysilsesquioxane is present in an amount sufficient to reduce degradation of the encapsulant upon exposure to elevated temperature and/or high optical flux density during operation of the lighting device.

23. A method of claim 21, wherein the least one the functionalized polyhedral oligomeric silsesquioxane and/or the functionalized polysilsesquioxane further comprises at least one of a C₁₋₃₀ alkyl and/or a C₆₋₃₀ aryl.

24. A method of claim 23, wherein the one functionalized polyhedral oligomeric silsesquioxane and/or the at least one functionalized polysilsesquioxane comprises at least one of ethyl, butyl, isooctyl, cyclopentyl, cyclohexyl, phenyl, and aryl.

25. A method of claim 24, wherein the one functionalized polyhedral oligomeric silsesquioxane and/or the at least one functionalized polysilsesquioxane comprises at least one of silyl, vinyl, styrenyl, thiol, diol, diamine, siloxy, epoxide, methacryl, acryl, methacrylamidyl, acrylamidyl, nitrile, isocyanate, isothiocyanate, carboxyl, hydroxyl, and norbornenyl.

26. A method of claim 24, wherein the one functionalized polyhedral oligomeric silsesquioxane and/or the at least one functionalized polysilsesquioxane comprises at least one of silyl, vinyl, and hydroxyl.

27. A method of claim 21, wherein the encapsulant further comprises a matrix material selected from at least one of a polymer or an oligomer of polysilicones, polydialklysiloxanes, polyalkylaryl siloxanes, polydiarylsiloxane, and copolymers thereof.

28. A method of claim 21, wherein the encapsulant further comprises a matrix material selected from at least one of a polymer or an oligomer of epoxy resins, polyesters, polyarylesters, polyurethanes, cyclic olefinic copolymers (COC's), polynorbornenes, and copolymers thereof.

29. A method of claim 21, wherein the encapsulant comprises a mixture and/or a reaction product of:
(i) at least one functionalized polyhedral oligomeric silsesquioxane and/or at least one functionalized polysilsesquioxane comprising at least one functional group selected from silyl, hydroxy, alkoxy, amine, chlorine, epoxide, isocyanate, methacrylate, acrylate, methacrylamide, acrylamide, nitrile, isocyanate, isothiocyanate, norbornenyl, vinyl, styrenyl, and thiol;
(ii) a matrix selected from at least one polymer or oligomer of polydialklysiloxanes, polyalkylaryl siloxanes, and/or polydiarylsiloxanes, the matrix comprising at least one silyl, hydroxy, alkoxy, amine, chlorine, epoxide, isocyanate, isothiocyanate, nitrile, vinyl and thiol, acrylate, methacrylate, acrylamide, methacrylamide, fumarate, maleate, norbornenyl and styrene functional groups; and
optionally, a catalyst.

30. A method of claim 21, wherein encapsulant is formed by a mixture and/or a reaction product of:
(i) at least one of trishydroxy phenyl-POSS, trishydroxy ethyl-POSS, trishydroxy phenyl-POSS, octadimethylhydrosilyl-POSS, octavinyl-POSS and octavinyldimethylsilyl-POSS;
(ii) a matrix selected from polydialklysiloxanes, polyalkylaryl siloxanes, and/or polydiarylsiloxanes, the matrix comprising at least one of a vinyl, silyl, and/or a hydroxyl-containing functional group; and
a catalyst.

31. A method of claim 21, wherein the catalyst comprises platinum and the encapsulant comprises a molar excess of vinyl groups associated with the at least one functionalized polyhedral oligomeric silsesquioxane and/or the at least one functionalized polysilsesquioxanes to that of the platinum catalyst.

32. A method of increasing the thermal conductivity of an encapsulant for a lighting device, the method comprising:
providing an encapsulant precursor configured for forming an encapsulant for at least one light emitter, the encapsulant precursor comprising a mixture or reaction product of at least one functionalized polyhedral oligomeric silsesquioxane and/or at least one functionalized polysilsesquioxanes present in an amount sufficient to increase the thermal conductivity of the encapsulant.

33. The method of claim 32, further comprising the steps of providing the at least one light emitter; introducing the encapsulant precursor to the at least one light emitter; and forming the encapsulant in proximity to the at least one light emitter.

34. A method of increasing the refractive index of an encapsulant for a lighting device, the method comprising:
providing an encapsulant precursor configured for forming an encapsulant for at least one light emitter, the encapsulant precursor comprising a mixture or reaction product of at least one functionalized polyhedral oligomeric silsesquioxane and/or at least one functionalized polysilsesquioxane present in an amount sufficient to increase the refractive index of the encapsulant.

35. The method of claim 34, further comprising the steps of providing the at least one light emitter; introducing the encapsulant precursor to the at least one light emitter; and forming the encapsulant in proximity to the at least one light emitter.
